(19) United States
(12) Patent Application Publication
(10) Pub. No.: US 2026/0360921 A1
(43) Pub. Date: Nov. 12, 2026

(54) SEPARATOR FOR LITHIUM SECONDARY BATTERY AND LITHIUM SECONDARY BATTERY COMPRISING SAME

(71) Applicant: LG ENERGY SOLUTION, LTD., Seoul (KR)

(72) Inventors: Yoo-Jin LEE, Daejeon (KR); Ji-Yeon KIM, Daejeon (KR); Ji-Eun KIM, Daejeon (KR); Ki-Ryuk BANG, Daejeon (KR); Yong-Hyeok LEE, Daejeon (KR)

(73) Assignee: LG ENERGY SOLUTION, LTD., Seoul (KR)

(21) Appl. No.: 19/673,580

(22) Filed: May 11, 2026

(30) Foreign Application Priority Data
May 12, 2025 (KR) 10-2025-0061335

(51) Int. Cl. H01M 50/446; H01M 10/052; H01M 50/42; H01M 50/423; H01M 50/426; H01M 50/434; H01M 50/443; H01M 50/451; H01M 50/46; H01M 50/491

(52) U.S. Cl. CPC H01M 50/446; H01M 10/052; H01M 50/42; H01M 50/423; H01M 50/426; H01M 50/434; H01M 50/443; H01M 50/451; H01M 50/461; H01M 50/491

(57) ABSTRACT

Provided is a separator for a lithium secondary battery, including: a porous polymer substrate; and an inorganic heat-resistant layer present on at least one surface of the porous polymer substrate and including inorganic particles, an alcohol group-containing non-particle-type binder polymer and an acrylic particle-type binder polymer.

### CROSS-REFERENCE TO RELATED APPLICATIONS

This application is based on and claims priority from Korean Patent Application No. 10-2025-0061335 filed on May 12, 2025 with the Korean Intellectual Property Office, the disclosure of which is incorporated herein in its entirety by reference.

### TECHNICAL FIELD

The present disclosure relates to a separator for a lithium secondary battery and a lithium secondary battery including the same.

### BACKGROUND

In general, an electrochemical device, such as a lithium secondary battery, includes a positive electrode, a separator, a negative electrode and an electrolyte, as fundamental constitutional elements, and is a high-energy density energy storage device capable of charging and discharging through reversible conversion of chemical energy and electrical energy. For this reason, it has been used widely for compact electronic appliances, such as cellular phones, notebook PCs, or the like.

Recently, in response to environmental issues, high oil prices and an increasing need for energy efficiency and storage, application of such electrochemical devices has been extended to hybrid electric vehicles (HEVs), plug-in hybrid electric vehicles (PHEVs), electric bikes (e-bikes), energy storage systems (ESSs), or the like.

In manufacturing and using such a lithium secondary battery, ensuring the safety of a lithium secondary battery is an important problem. Particularly, a separator used generally in a lithium secondary battery may undergo heat shrinking under a severe condition, such as high temperature, thereby causing a safety-related problem, such as an internal short-circuit. Therefore, recently, there has been suggested a composite porous separator formed by coating an inorganic heat-resistant layer including inorganic particles and a binder polymer on a porous polymer substrate.

Meanwhile, such an inorganic heat-resistant layer is generally formed on a porous polymer substrate by using a water-dispersible slurry, and if necessary, a structure having an adhesive layer formed additionally on the inorganic heat-resistant layer has been suggested. However, the porous polymer substrate has hydrophobicity, and thus undergoes degradation of wettability while applying the water-dispersible slurry, which may cause a problem of difficulty in carrying out uniform coating.

To solve the above-mentioned wettability-related problem, a method of incorporating a wetting agent to the slurry has been suggested according to the related art. However, when the wetting agent is contained in a large amount, a problem may occur in that the electrochemical properties, such as resistance characteristics, of the separator may be degraded or the life characteristics thereof may be deteriorated.

Meanwhile, as a method for ensuring wettability while reducing the use of a wetting agent, use of an alcohol group-containing binder polymer has been suggested. However, in this case, the viscosity and coating behavior of the slurry cannot be controlled suitably, thereby making it difficult to form an inorganic heat-resistant layer uniformly on a porous polymer substrate.

Therefore, there is a technical need for an inorganic heat-resistant layer which can ensure excellent coatability while reducing the use of a wetting agent and can prevent degradation of electrochemical performance at the same time, and a separator including the same.

### SUMMARY

### Technical Problem

The present disclosure is directed to providing a separator for a lithium secondary battery which allows an inorganic heat-resistant layer to be formed uniformly on a porous polymer substrate by using a water-dispersible slurry while reducing the use of a wetting agent.

The present disclosure is also directed to providing a separator capable of inhibiting detachment of inorganic particles by ensuring excellent water resistance even in an aqueous environment, through an inorganic heat-resistant layer including an alcohol group-containing non-particle-type binder polymer together with an acrylic particle-type binder polymer.

In addition, the present disclosure is directed to providing a separator which allows stable formation of an adhesive layer with no loss of an inorganic heat-resistant layer even when applying an aqueous slurry for forming an adhesive layer, and thus maintains excellent resistance characteristics.

Further, the present disclosure is directed to providing a separator which stably maintains air permeability and heat shrinkage property by inhibiting collapse or excessive opening of a pore structure by virtue of the maintenance of the structural stability of the inorganic heat-resistant layer.

However, the technical problems to be solved by the present disclosure are not limited to the above-described problems, and other problems not mentioned will be clearly understood by those skilled in the art from the description of the present disclosure described below.

### Technical Solution

To achieve at least some of the above-described objects, according to one aspect of the present disclosure, there are provided a separator for a lithium secondary battery and a lithium secondary battery including the same according to the embodiments disclosed herein.

According to a first embodiment of the present disclosure, there is provided a separator for a lithium secondary battery, including: a porous polymer substrate; and an inorganic heat-resistant layer present on at least one surface of the porous polymer substrate and including inorganic particles, an alcohol group-containing non-particle-type binder polymer and an acrylic particle-type binder polymer.

According to a second embodiment, in the first embodiment, the alcohol group-containing non-particle-type binder polymer may include a vinyl alcohol-derived repeating unit.

According to a third embodiment, in the first or the second embodiment, the alcohol group-containing non-particle-type binder polymer may have a degree of hydrolysis of 80 mol % to 95 mol %.

According to a fourth embodiment, in any one of the first to the third embodiments, the acrylic particle-type binder polymer may have a particle diameter (D₅₀) of 50 nm or more and 500 nm or less.

According to a fifth embodiment, in any one of the first to the fourth embodiments, a weight ratio of the acrylic particle-type binder polymer to the alcohol group-containing non-particle-type binder polymer may be larger than 1.

According to a sixth embodiment, in any one of the first to the fifth embodiments, a weight ratio of the alcohol group-containing non-particle-type binder polymer to the acrylic particle-type binder polymer may be 1:1.5 to 1:20.

According to a seventh embodiment, in any one of the first to the sixth embodiments, the inorganic heat-resistant layer may further include an amide group-containing binder polymer.

According to a eighth embodiment, in the seventh embodiment, the amide group-containing binder polymer may include a polyacrylamide-based binder polymer.

According to a ninth embodiment, in the seventh or the eighth embodiment, the amide group-containing binder polymer may be a non-particle-type binder polymer.

According to a tenth embodiment, in any one of the first to the ninth embodiments, the inorganic heat-resistant layer may include, based on 100 wt % of the inorganic heat-resistant layer, 0.1 wt % to 10 wt % of the alcohol group-containing non-particle-type binder polymer and 0.2 wt % to 20 wt % of the acrylic particle-type binder polymer.

According to a eleventh embodiment, in any one of the first to the ninth embodiments, the inorganic heat-resistant layer may further include a wetting agent in an amount of less than 1 wt % based on 100 wt % of the inorganic heat-resistant layer.

According to a twelfth embodiment, in any one of the first to the eleventh embodiments, the inorganic particles may include boehmite (AlOOH).

According to a thirteenth embodiment, in any one of the first to the twelfth embodiments, the separator for a lithium secondary battery may further include an adhesive layer present on at least one surface of the inorganic heat-resistant layer and including at least one adhesive-layer binder polymer.

According to a fourteenth embodiment, in the thirteenth embodiment, the adhesive-layer binder polymer may comprise a particle-type binder polymer, a non-particle-type binder polymer or a combination thereof.

According to a fifteenth embodiment, in the thirteenth or the fourteenth embodiment, the adhesive-layer binder polymer may include an acrylic binder polymer, a polyvinylidene fluoride (PVDF)-based binder polymer or a combination thereof.

According to a sixteenth embodiment, there is provided a lithium secondary battery including: a positive electrode; a negative electrode; and a separator interposed between the positive electrode and the negative electrode, wherein the separator may be according to any embodiments disclosed herein.

### Advantageous Effects

A separator according to an embodiment of the present disclosure may allow an inorganic heat-resistant layer to be formed uniformly on a porous polymer substrate by using a water-dispersible slurry while reducing the use of a wetting agent.

A separator according to an embodiment of the present disclosure may include an alcohol group-containing non-particle-type binder polymer together with an acrylic particle-type binder polymer and may have excellent water resistance even in an aqueous environment, and thus may effectively inhibit detachment of the inorganic particles from the inorganic heat-resistant layer.

Additionally, a separator according to an embodiment of the present disclosure may allow uniform formation of an adhesive layer with no loss or substantially no loss of an inorganic heat-resistant layer even when applying an aqueous slurry for forming an adhesive layer onto the inorganic heat-resistant layer, based on such water resistance.

Additionally, a separator according to an embodiment of the present disclosure may have improved durability through the uniform formation of the inorganic heat-resistant layer and maintenance of the structural stability, and thus may show a reduced heat shrinkage and improved interfacial stability.

In addition, a separator according to an embodiment of the present disclosure may maintain excellent resistance characteristics through the stable maintenance of the inorganic heat-resistant layer and may prevent degradation of battery performance.

Further, a separator according to an embodiment of the present disclosure may maintain excellent physical properties while minimizing an increase in total thickness even though the inorganic heat-resistant layer and the adhesive layer are formed.

Meanwhile, the effects obtained through the present disclosure are not limited to the above-described effects, and other technical effects not mentioned may be clearly understood by those skilled in the art from the following description of the present disclosure.

### DETAILED DESCRIPTION

It should be understood that the terms used in the specification and the appended claims should not be construed as limited to general and dictionary meanings, but interpreted based on the meanings and concepts corresponding to technical aspects of the present disclosure on the basis of the principle that the inventor is allowed to define terms appropriately for the best explanation.

The terms used in the present specification are used to describe exemplary embodiments, not intended to limit the scope of the present disclosure. Singular forms used in the present specification also include plural forms unless the phrases clearly indicate the opposite meaning.

### DEFINITION

Throughout the specification, the expression a part ‘includes’ an element does not preclude the presence of any additional elements but means that the part may further include the other elements.

Throughout the specification, ‘glass transition temperature (Tg)’ may represent a value determined, for example, by dynamic mechanical analysis (DMA) or differential scanning calorimetry (DSC, TA instrument) equipment. For example, the glass transition temperature may represent a value determined by the DMA method defined in ASTM D4065.

Throughout the specification, Dₙ refers to the particle diameter at the n % point of the cumulative distribution of the number of particles according to the particle diameter. In other words, D₅₀ refers to the particle diameter at 50% point of the cumulative distribution of the number of particles according to the particle diameter. In addition, D₁₀ refers to the particle diameter at 10% point of the cumulative distribution of the number of particles according to the particle diameter, and D₉₀ refers to the particle diameter at 90% point of the cumulative distribution of the number of particles according to the particle diameter.

Throughout the specification, the particle diameter may be determined by using a laser diffraction method. Specifically, a powder to be analyzed is dispersed in a dispersion medium and introduced to a commercially available laser diffraction particle size analyzer (e.g. Microtrac 53500) to measure a difference in diffraction pattern depending on particle size, when the particles pass through laser beams, and then the particle size distribution is calculated. Then, D₁₀, D₅₀ and D₉₀ be determined by calculating the particle diameter at the point of 10%, 50% and 90%, respectively, in the cumulative distribution of the number of particles according to the particle diameter in the analyzer system. The particle diameter may be a volume-based particle diameter.

Otherwise, the particle diameter may be determined by observing particles with a scanning electron microscope (SEM), measuring particle sizes through image analysis and calculating the particle size distribution to calculate the particle diameter at the point of 10%, 50% and 90%, respectively, in the cumulative distribution of the number of particles. In this manner, each of D₁₀, D₅₀ and D₉₀ be determined.

In one aspect of the present disclosure, there is provided a separator for a lithium secondary battery.

The separator for a lithium secondary battery according to an embodiment of the present disclosure includes: a porous polymer substrate; and an inorganic heat-resistant layer present on at least one surface of the porous polymer substrate and including inorganic particles, an alcohol group-containing non-particle-type binder polymer and an acrylic particle-type binder polymer.

### <Porous Polymer Substrate>

The separator for a lithium secondary battery according to the present disclosure includes a porous polymer substrate.

According to an embodiment of the present disclosure, the porous polymer substrate means a porous ion-conducting barrier which allows ions to pass therethrough, while interrupting an electrical contact between a negative electrode and a positive electrode, and having a plurality of pores formed therein. The pores are interconnected so that gases or liquids may pass from one surface of the substrate to the other surface of the substrate.

Materials forming the porous polymer substrate may be any organic materials or inorganic materials having electrical insulation property. Particularly, with a view to imparting a shut-down function to a substrate, it is disclosed to use a thermoplastic resin as a material forming the porous polymer substrate. Herein, the term ‘shut-down function’ means a function of preventing a battery from thermal runaway by allowing a thermoplastic resin to be molten so that the pores of the porous substrate may be closed and ion conduction may be interrupted, when the battery temperature is increased. As a thermoplastic resin, a thermoplastic resin having a melting point of less than 200 °C is suitable, polyolefin being disclosed.

In addition to polyolefin, the thermoplastic resin may include at least one selected from polymer resins, such as polyethylene terephthalate, polybutylene terephthalate, polyacetal, polyamide, polycarbonate, polyimide, polyetherether ketone, polyether sulfone, polyphenylene oxide, polyphenylene sulfide and polyethylene naphthalate. The porous polymer substrate may include a non-woven web, a porous polymer film, or a laminate of two or more layers thereof, but is not limited thereto.

According to the present disclosure, the porous polymer substrate may have a thickness of 3 μm to 50 μm, or 4 μm to 12 μm. When the thickness is smaller than the above-defined range of 3 μm to 50 μm, the porous polymer substrate may show an insufficient function as a conducting barrier and may have degraded physical properties, and thus the separator may be damaged during battery use. On the other hand, when the thickness is excessively larger than the above-defined range of 3 μm to 50 μm (i.e., the porous substrate is excessively thick), the separator may show excessively increased resistance.

According to an embodiment of the present disclosure, polyolefin may have a weight average molecular weight of 100,000 to 5,000,000. When the weight average molecular weight is smaller than 100,000, it may be difficult to ensure sufficient dynamic physical properties. In addition, when the weight average molecular weight is larger than 5,000,000, shut-down characteristics may be degraded, or molding may become difficult. In addition, the porous polymer substrate may have a puncture strength of 300 gf or more in terms of improvement of production yield. The puncture strength of a porous substrate refers to the highest puncture load (gf) measured by carrying out a puncture test with Kato tech KES-G5 handy compression tester under the conditions of a needle tip radius of curvature of 0.5 mm and a puncture rate of 4 mm/sec.

According to an embodiment of the present disclosure, the size of the pores present in the porous polymer substrate and the porosity are not particularly limited, but may be 0.01 μm to 50 μm and 10 vol % to 95 vol %, respectively.

### <Inorganic Heat-Resistant Layer>

The separator for a lithium secondary battery according to the present disclosure includes an inorganic heat-resistant layer present on at least one surface of the porous polymer substrate and including inorganic particles, an alcohol group-containing non-particle-type binder polymer and an acrylic particle-type binder polymer.

According to an embodiment of the present disclosure, the inorganic heat-resistant layer may be formed by mixing a inorganic particles, an alcohol group-containing non-particle-type binder polymer and an acrylic particle-type binder polymer. Such a separator may have improved heat resistance and mechanical properties. In addition, the inorganic heat-resistant layer may be formed on one surface or both surfaces of the porous polymer substrate. When the inorganic heat-resistant layer is formed on both surfaces of the porous polymer substrate, the heat resistance and mechanical properties of the separator may be improved more uniformly.

In the present specification, the ‘non-particle-type’ binder polymer may refer to a binder polymer not retaining a particle shape during coating and drying even though it may be present in a state dissolved in a solvent or in the form of particles in a dispersion medium. The ‘particle-type’ binder polymer may refer to a binder polymer present in the form of particles in a dispersion medium and retaining a particle shape even after coating and drying.

According to an embodiment of the present disclosure, the alcohol group-containing non-particle-type binder polymer may include a vinyl alcohol-derived repeating unit. The alcohol group-containing non-particle-type binder polymer may be a homopolymer including a vinyl alcohol-derived repeating unit alone, or a copolymer including another repeating unit or plural other repeating units besides a vinyl alcohol-derived repeating unit.

The alcohol group-containing non-particle-type binder polymer may have an amphiphilic structure containing both a hydrophilic functional group and a hydrophobic functional group, and thus can ensure wettability of a water-dispersible slurry even if a separate wetting agent is not used, or the use of a wetting agent is reduced. Specifically, the hydrophilic functional group of the alcohol group-containing non-particle-type binder polymer may improve the binding force with the inorganic particles and another binder polymer, and the hydrophobic functional group may improve the adhesion with the porous polymer substrate. As a result, the inorganic heat-resistant layer may be formed uniformly, and the separator may have improved resistance characteristics and life characteristics.

According to an embodiment of the present disclosure, the alcohol group-containing non-particle-type binder polymer may include a polyvinyl alcohol-based binder polymer. The polyvinyl alcohol-based binder polymer may be polyvinyl alcohol, modified polyvinyl alcohol or a combination thereof, and may be a non-particle-type and water-soluble polymer.

According to an embodiment of the present disclosure, the modified polyvinyl alcohol may be polyvinyl alcohol modified with a functional group, such as a carboxyl group, a sulfonic acid group, an amino group, a silanol group, a thiol group, or the like.

According to an embodiment of the present disclosure, the alcohol group-containing non-particle-type binder polymer may have a degree of hydrolysis of 80 mol % to 95 mol %, 83 mol % to 92 mol %, or 85 mol % to 90 mol %. The degree of hydrolysis of the alcohol group-containing non-particle-type binder polymer may refer to a ratio of hydroxylated alcohol groups based on the total alcohol groups in the alcohol group-containing non-particle-type binder polymer. When the degree of hydrolysis of the alcohol group-containing non-particle-type binder polymer is less than the lower limit, it might not be dissolved in an aqueous solvent, and thus may not be suitable to be used for an aqueous coating solution. When the degree of hydrolysis exceeds the upper limit, the hydrophilic groups may be increased excessively, and thus it may not be possible to perform coating on a porous polymer substrate.

According to an embodiment of the present disclosure, the alcohol group-containing non-particle-type binder polymer may have a weight average molecular weight (Mw) of 100,000 to 500,000, or 200,000 to 400,000.

According to an embodiment of the present disclosure, the acrylic particle-type binder polymer may be a water-insoluble polymer and may be present in the form of particles in an aqueous dispersion medium. In other words, it may be present in the form of latex/emulsion particles in an aqueous dispersion medium. The acrylic particle-type binder polymer may improve the water resistance of the inorganic heat-resistant layer and reinforce the binding force among the inorganic particles, thereby allowing the inorganic heat-resistant layer to maintain the structural stability even in an aqueous environment. Therefore, it may be possible to inhibit detachment of the inorganic heat-resistant layer even when an aqueous slurry for forming an adhesive layer is subsequently applied.

According to an embodiment of the present disclosure, the acrylic particle-type binder polymer may be in the form of an emulsion in a dispersion medium.

According to an embodiment of the present disclosure, the acrylic particle-type binder polymer may have a particle diameter (D₅₀) of 50 nm or more and 500 nm or less, 80 nm or more and 400 nm or less, or 100 nm or more and 350 nm or less.

According to an embodiment of the present disclosure, the acrylic particle-type binder polymer may have a glass transition temperature in a range of −100 °C to 50 °C, or −60 °C to 40 °C.

According to an embodiment of the present disclosure, the acrylic particle-type binder polymer may be a homopolymer containing an acrylate-based monomer alone, or may include a copolymer of an acrylate-based monomer and another monomer or plural other monomers. For example, the polyacrylate-based binder polymer may include poly(methyl methacrylate), poly(ethylhexyl acrylate), poly(butyl acrylate), poly(acrylonitrile), poly(ethylhexylacrylate-co-methyl methacrylate), poly(butyl acrylate-co-methyl methacrylate), ethyl acrylate-acrylic acid-N,N-dimethyl acrylamide copolymer, ethyl acrylate-acrylic acid-2-(dimethylamino)ethyl acrylate copolymer, ethyl acrylate-acrylic acid-N,N-diethylacrylamide copolymer, ethyl acrylate-acrylic acid-2-(diethylamino)ethyl acrylate copolymer, or a mixture of two or more of them.

According to an embodiment of the present disclosure, a weight ratio of the acrylic particle-type binder polymer to the alcohol group-containing non-particle-type binder polymer may be larger than 1.

According to an embodiment of the present disclosure, a weight ratio of the alcohol group-containing non-particle-type binder polymer to the acrylic particle-type binder polymer may be in a range of 1:1.5 to 1:20, 1:2 to 1:10, or 1:2 to 1:8. When the weight ratio satisfies the above-defined range of 1:1.5 to 1:20, it may be possible to form an adhesive layer more uniformly since detachment of the inorganic particles is low even when an aqueous slurry for forming an adhesive layer is subsequently applied onto the inorganic heat-resistant layer, and to realize higher heat resistance characteristics.

According to an embodiment of the present disclosure, the inorganic heat-resistant layer may further include an amide group-containing binder polymer. The amide group-containing binder polymer may have excellent heat resistance characteristics. Therefore, even with a small amount of amide group-containing binder polymer, it may be possible to realize excellent heat resistance characteristics.

According to an embodiment of the present disclosure, the amide group-containing binder polymer may include a polyacrylamide-based binder polymer.

According to an embodiment of the present disclosure, particular examples of the polyacrylamide-based binder polymer may include polyacrylamide, crosslinked polyacrylamide, anionic polyacrylamide, cationic polyacrylamide, non-ionic polyacrylamide, polyacrylamide-polyacrylic acid copolymer, such as ethyl acrylate-acrylic acid-N,N-dimethylacrylamide copolymer or ethyl acrylate-acrylic acid-N,N-diethylacrylamide copolymer, polyacrylamide-polyacryloylmorpholine copolymer, modified polyacrylamide, such as N-alkyl polyacrylamide, N-hydroxyethyl polyacrylamide or carboxymethyl polyacrylamide, or a mixture of two or more of them.

According to an embodiment of the present disclosure, the amide group-containing binder polymer may be a non-particle-type amide group-containing binder polymer. In other words, when using an aqueous solvent as a solvent of a slurry for forming an inorganic heat-resistant layer, the polyacrylamide-based binder polymer may be present in a non-particle shape in the solvent.

According to an embodiment of the present disclosure, the polyacrylamide-based binder polymer may be a water-soluble binder polymer.

According to an embodiment of the present disclosure, the polyacrylamide-based binder polymer may include a repeating unit or repeating units other than an acrylamide-based monomer-derived repeating unit, as its repeating unit. For example, the polyacrylamide-based binder polymer may further include an acrylate-based monomer-derived repeating unit, etc., as an additional repeating unit.

According to an embodiment of the present disclosure, the amide group-containing binder polymer may have a weight average molecular weight of 200,000 to 500,000, or 250,000 to 400,000.

According to an embodiment of the present disclosure, the inorganic heat-resistant layer may include the amide group-containing binder polymer in an amount of 1 wt % to 20 wt %, 2 wt % to 18 wt %, or 3 wt % to 17 wt %, based on 100 wt % of the total weight of the inorganic heat-resistant layer. When the above-defined range is satisfied, the inorganic heat-resistant layer may show higher heat resistance.

According to an embodiment of the present disclosure, the inorganic heat-resistant layer may include the alcohol group-containing non-particle-type binder polymer in an amount of 0.1 wt % to 10 wt %, or 0.5 wt % to 8 wt %, based on 100 wt % of the total weight of the inorganic heat-resistant layer. When the above-defined range of 1 wt % to 20 wt % is satisfied, detachment of the inorganic particles may be low, peel strength of the porous polymer substrate-inorganic heat-resistant layer may be excellent, and the inorganic heat-resistant layer may be formed more stably on the porous polymer substrate even when the use of a wetting agent is reduced.

According to an embodiment of the present disclosure, the inorganic heat-resistant layer may include the acrylic particle-type binder polymer in an amount of 0.2 wt % to 20 wt %, or 1 wt % to 16 wt %, based on 100 wt % of the total weight of the inorganic heat-resistant layer. When the above-defined range of 0.2 wt % to 20 wt % is satisfied, water resistance of the inorganic heat-resistant layer may be further improved.

According to an embodiment of the present disclosure, the inorganic heat-resistant layer may further include a wetting agent in an amount of less than 1 wt %, less than 0.7 wt %, less than 0.5 wt %, less than 0.3 wt %, less than 0.2 wt % or less than 0.1 wt %, based on 100 wt % of the inorganic heat-resistant layer. When the above-defined range of less than 1 wt % is satisfied, coating rate may be increased when manufacturing a separator while limiting an increase in resistance of the separator, thereby realizing higher productivity.

According to an embodiment of the present disclosure, the wetting agent may refer to any known wetting agent, such as a fluorine-based surfactant, a siloxane-based surfactant, a hydrocarbon-based surfactant and an ether-based surfactant.

According to an embodiment of the present disclosure, the inorganic heat-resistant layer may have a microporous structure derived from the interstitial volume among the inorganic particles. The inorganic particles may also serve as a kind of spacer capable of retaining the physical shape of the inorganic heat-resistant layer. The interstitial volume refers to a limited space in which the inorganic particles are substantially in contact with one another. In addition, since the inorganic particles are generally characterized in that they do not undergo a change in physical properties even at a high temperature of 200 °C or higher, the separator may have excellent heat resistance by virtue of the inorganic heat-resistant layer.

There is no particular limitation in the inorganic particles, as long as they are electrochemically stable. In other words, the inorganic particles that may be used in the present disclosure are not particularly limited, as long as they do not cause oxidation and/or reduction in the range (e.g. 0 V to 5 V based on Li/Li⁺) of operating voltage of an applicable electrochemical device. Particularly, when using inorganic particles having a high dielectric constant as the inorganic particles, it may be possible to improve the ion conductivity of an electrolyte by increasing the dissociation degree of an electrolyte salt, such as a lithium salt, in a liquid electrolyte.

For these reasons, the inorganic particles may include high-dielectric constant inorganic particles having a dielectric constant of 5 or more, or 10 or more. Non-limiting examples of the inorganic particles having a dielectric constant of 5 or more include BaTiO₃, Pb(Zr,Ti)O₃ (PZT), Pb₁₋ₓLaₓZr_{1-y}Ti_{y}O₃ (PLZT, 0<x<1, 0<y<1), Pb(Mg_{1/3}Nb_{2/3})O₃—PbTiO₃ (PMN-PT), hafnia (HfO₂), SrTiO₃, SnO₂, CeO₂, MgO, NiO, CaO, ZnO, ZrO₂, SiO₂, Y₂O₃, Al₂O₃, AlOOH, SiC, TiO₂ or a mixture thereof, etc.

In addition, the inorganic particles may include inorganic particles having lithium ion transportability, i.e., inorganic particles which contain elemental lithium and do not store lithium but function to transport lithium ions. Non-limiting examples of the inorganic particles having lithium ion transportability include lithium phosphate (Li₃PO₄), lithium titanium phosphate (LiₓTi_{y}(PO₄)₃, 0<x<2, 0<y<3), lithium aluminum titanium phosphate (LiₓAl_{y}Ti_{z}(PO₄)₃, 0<x<2, 0<y<1, 0<z<3), (LiAlTiP)ₓO_{y}-based glass (1<x<4, 0<y<13), such as 14Li₂O-9Al₂O₃-38TiO₂-39P₂O₅, lithium lanthanum titanate (LiₓLa_{y}TiO₃, 0<x<2, 0<y<3), lithium germanium thiophosphate (LiₓGe_{y}P_{z}S_{w}, 0<x<4, 0<y<1, 0<z<1, 0<w<5), such as Li_{3.25}Ge_{0.25}P_{0.75}S₄, lithium nitride (LiₓN_{y}, 0<x<4, 0<y<2), such as Li₃N, SiS₂-based glass (LiₓSi_{y}S_{z}, 0<x<3, 0<y<2, 0<z<4), such as Li₃PO₄—Li₂S—SiS₂, P₂S₅-based glass (LiₓP_{y}S_{z}, 0<x<3, 0<y<3, 0<z<7), such as LiI—Li₂S—P₂S₅, or a mixture thereof, etc.

According to an embodiment of the present disclosure, the inorganic particles may include boehmite (AlOOH). For example, the inorganic particles may include boehmite (AlOOH), or may include boehmite (AlOOH) and alumina (Al₂O₃).

According to an embodiment of the present disclosure, the average particle diameter (D₅₀) of the inorganic particles is not particularly limited, but for example, the inorganic particles may have an average particle diameter of 100 nm to 1000 nm, or 100 nm to 800 nm.

According to an embodiment of the present disclosure, the content of the inorganic particles may be 80 wt % to 98 wt %, or 85 wt % to 97 wt %, based on 100 wt % of the inorganic heat-resistant layer. When the content of the inorganic particles satisfies the above-defined range of 80 wt % to 98 wt %, the inorganic heat-resistant layer may have high density, and the separator may realize excellent porosity and resistance characteristics.

According to an embodiment of the present disclosure, the inorganic heat-resistant layer may further include an amide group-containing binder polymer, and the amide group-containing binder polymer may include a polyacrylamide-based binder polymer. The polyacrylamide-based binder polymer may be a non-particle-type water-soluble polyacrylamide-based binder polymer, and may enhance the binding force between the inorganic heat-resistant layer and the porous polymer substrate and may improve heat resistance characteristics.

According to an embodiment of the present disclosure, the weight ratio of the acrylic particle-type binder polymer to the alcohol group-containing non-particle-type binder polymer may be larger than 1, and specifically the weight ratio of the alcohol group-containing non-particle-type binder polymer to the acrylic particle-type binder polymer may be in a range of 1:1.5 to 1:20. When the above-defined ranges are satisfied, detachment of the inorganic particles may be inhibited by virtue of excellent water resistance even when an aqueous slurry for forming an adhesive layer is applied, and excellent resistance characteristics and heat resistance characteristics may be retained.

According to an embodiment of the present disclosure, the inorganic heat-resistant layer may include 0.1 wt % to 10 wt % of the alcohol group-containing non-particle-type binder polymer and 0.2 wt % to 20 wt % of the acrylic particle-type binder polymer, based on 100 wt % of the total weight of the inorganic heat-resistant layer.

According to an embodiment of the present disclosure, the inorganic heat-resistant layer may have a thickness of 0.5 μm to 5 μm, 0.6 μm to 1.5 μm, 0.7 μm to 1.2 μm, or 0.8 μm to 1.1 μm. When the thickness of the inorganic heat-resistant layer satisfies the above-defined range of 0.5 μm to 5 μm, the separator may have excellent mechanical properties, heat resistance characteristics and resistance characteristics.

Meanwhile, the inorganic heat-resistant layer may be formed by mixing inorganic particles, an alcohol group-containing non-particle-type binder polymer and an acrylic particle-type binder polymer in a dispersion medium to prepare a slurry for forming an inorganic heat-resistant layer and applying the slurry onto at least one surface of a porous polymer substrate, followed by drying. In addition, the slurry for forming an inorganic heat-resistant layer may optionally further include an amide group-containing binder polymer.

According to an embodiment of the present disclosure, the dispersion medium may be an aqueous dispersion medium, which may be water or a water-containing mixed solvent. If necessary, in order to control a drying rate or process condition, a C₁-C₅ alcohol, such as methanol, ethanol, isopropyl alcohol, etc. may be used in combination. When using such an aqueous dispersion medium, the acrylic particle-type binder polymer may not be dissolved in the dispersion medium but may be dispersed while retaining its particle shape.

According to an embodiment of the present disclosure, the slurry for forming an inorganic heat-resistant layer may have a solid content except the dispersion medium of 10 wt % to 70 wt %, 20 wt % to 60 wt %, or 30 wt % to 50 wt %.

According to an embodiment of the present disclosure, there is no particular limitation in the method for applying the slurry for forming an inorganic heat-resistant layer onto at least one surface of the porous polymer substrate. For example, the slurry for forming an inorganic heat-resistant layer may be applied by using dip coating, die coating, roll coating, comma coating, microgravure coating, doctor blade coating, reverse roll coating, Mayer bar coating, direct metering coating or a combination thereof.

According to an embodiment of the present disclosure, the method for drying the slurry is not particularly limited. For example, at least one method selected from convection drying, hot air drying, air blowing drying and natural drying may be used. The drying method may be hot air drying in particular.

According to an embodiment of the present disclosure, the drying step may be carried out at a temperature of 55 °C to 68 °C. When the temperature range of 55 °C to 68 °C is satisfied, the inorganic particles may be disposed more stably in the inorganic heat-resistant layer so that durability and mechanical strength may be improved.

In addition, the drying step may be carried out for 10 seconds or more and 120 seconds or less at the above-defined range of temperature.

### <Adhesive Layer>

According to an embodiment of the present disclosure, the separator for a lithium secondary battery may further include an adhesive layer formed on at least one surface of the inorganic heat-resistant layer and containing an adhesive-layer binder polymer. For instance, the adhesive layer may be formed on a surface of the inorganic heat-resistant layer facing away from the porous polymer substrate. In instances where the inorganic heat-resistant layer is formed on both surfaces of the porous polymer substrate, the adhesive layer may be formed on one of both surfaces of the respective inorganic heat-resistant layers facing away from the porous polymer substrate. In other instances, where the inorganic heat-resistant layer is formed on one surface of the porous polymer substrate, the adhesive layer may be formed on a surface of inorganic heat-resistant layers facing away from the porous polymer substrate, and also formed on a surface of the porous polymer substrate facing away from the inorganic heat-resistant layer.

According to an embodiment of the present disclosure, the adhesive-layer binder polymer may comprise a particle-type binder polymer, a non-particle-type binder polymer or a combination thereof.

According to an embodiment of the present disclosure, the adhesive-layer binder polymer may include an acrylic binder polymer, a polyvinylidene fluoride (PVDF)-based binder polymer or a combination thereof.

According to an embodiment of the present disclosure, for example, the PVDF-based binder polymer may include polyvinylidene fluoride (PVDF) homopolymer, or a copolymer of a vinylidene fluoride-derived repeating unit and a repeating unit copolymerizable therewith. For example, the PVDF-based binder polymer may be a copolymer of a vinylidene fluoride-derived repeating unit and at least one repeating unit selected from a trifluoroethylene (TrFE)-derived repeating unit, tetrafluoroethylene (TFE)-derived repeating unit, hexafluoropropylene (HFP)-derived repeating unit, trichloroethylene (TrCE)-derived repeating unit, trichlorofluoroethylene (TCFE)-derived repeating unit, chlorotrifluoroethylene (CTFE)-derived repeating unit, polymethyl methacrylate (PMMA)-derived repeating unit, 1,2-difluoroethylene-derived repeating unit, perfluoro(methylvinyl) ether-derived repeating unit, perfluoro(ethylvinyl) ether-derived repeating unit, perfluoro(propylvinyl)-derived repeating unit, perfluoro(2,2-dimethyl-1,3-dioxole)-derived repeating unit and polyvinyl acetate (PVAc)-derived repeating unit.

According to an embodiment of the present disclosure, the particle-type PVDF-based binder polymer may be a copolymer (PVDF-HFP) containing a vinylidene fluoride-derived repeating unit and hexafluoropropylene-derived repeating unit.

According to an embodiment of the present disclosure, the content of the hexafluoropropylene-derived repeating unit may be 1 wt % to 20 wt %, 10 wt % to 15 wt %, or 12 wt % to 13 wt %, based on 100 wt % of the total weight of the copolymer. When the content of the hexafluoropropylene-derived repeating unit satisfies the above-defined range of 1 wt % to 20 wt %, the PVDF-based binder polymer may have increased polarity and excellent dry adhesion and may show non-excessive solubility to an electrolyte so that the separator may show excellent wet adhesion, and the PVDF-based binder polymer may be distributed uniformly in the adhesive layer.

According to an embodiment of the present disclosure, the content of the comonomer in the PVDF-based polymer, i.e., the content of the hexafluoropropylene-derived repeating unit may be determined through a method of ¹H-NMR using Varian 500 MHz. Reference will be made to Journal of Materials Chemistry, 2012, 22, 341 or AMT-3412-0k, incorporated herein by reference, about the method in detail. The NMR spectrometry may use suitable equipment, such as Bruker Avance III HD 700 MHz NMR or Varian 500 MHz NMR.

According to an embodiment of the present disclosure, the particle-type PVDF-based binder polymer may be one having a glass transition temperature (Tg) of −30 °C to 40 °C, or −20 °C to 20 °C. In addition, the particle-type PVDF-based binder polymer may have a melting point (Tm) of 100 °C to 180 °C, or 130 °C to 150 °C.

According to an embodiment of the present disclosure, the acrylic binder polymer may include an acrylic homopolymer prepared by polymerizing acrylic monomers alone, or a copolymer of an acrylic monomer with another monomer or plural other monomers. For example, the acrylic binder polymer may include poly(methyl methacrylate), poly(ethylhexyl acrylate), poly(butyl acrylate), poly(acrylonitrile), poly(ethyl hexylacrylate-co-methyl methacrylate), poly(butyl acrylate-co-methyl methacrylate), ethyl acrylate-acrylic acid-N,N-dimethyl acrylamide copolymer, ethyl acrylate-acrylic acid-2-(dimethylamino)ethyl acrylate copolymer, ethyl acrylate-acrylic acid-N,N-diethylacrylamide copolymer, ethyl acrylate-acrylic acid-2-(diethylamino)ethyl acrylate copolymer, or a mixture of two or more of them.

According to an embodiment of the present disclosure, the adhesive layer may show a coverage of 30 area % or more, 40 area % or more, 50 area % or more, 60 area % or more, 70 area % or more, 80 area % or more, or 90 area % or more, and 100 area % or less, 98 area % or less, 96 area % or less, 94 area % or less, 92 area % or less, or 90 area % or less, based on 100 area % of the inorganic heat-resistant layer.

According to an embodiment of the present disclosure, the coverage occupied by the adhesive layer may be obtained through an SEM image observed with a scanning electron microscope (SEM) and image analysis thereof.

For example, after an arbitrary area (e.g. an area of 25 μm×25 μm) of the surface of the adhesive layer is observed with a scanning electron microscope (SEM) (for example, at a magnification of 5000) and an SEM image thereof is obtained, the SEM image may be classified by a gray level, and an area corresponding to a specific gray level corresponding to the inorganic particles may be classified. The gray level means a contrast value for a plurality of pixels included in the SEM image. For example, in an SEM image of 256 gray levels having steps 0 to 255, the range of the contrast value may be 0 to 255, and the inorganic particles may have, for example, 120 to 220 gray levels. Accordingly, the boundary of the inorganic particles may be set and defined from pixels having 120 to 220 gray levels in the SEM image of an arbitrary surface (e.g. a surface having a size of 25 μm×25 μm) of the separator, and the coverage occupied by the adhesive layer may be calculated.

Meanwhile, the adhesive layer may be formed by applying a slurry for forming an adhesive layer onto at least one surface of the inorganic heat-resistant layer, followed by drying. The slurry for forming an adhesive layer may be prepared by introducing a binder polymer, etc. to an aqueous dispersion medium.

According to an embodiment of the present disclosure, particular examples of the aqueous dispersion medium may include purified water, distilled water, deionized water, ultrapure water, or the like. According to an embodiment of the present disclosure, if necessary, the aqueous dispersion medium may be a mixed solvent of water and a water-soluble organic solvent, and for example, it may include a mixed solvent of water and methanol, ethanol, isopropyl alcohol, n-propanol, etc. According to an embodiment of the present disclosure, there is no particular limitation in the method for applying the aqueous slurry for forming an adhesive layer, and the above-described method for applying the slurry for forming an inorganic heat-resistant layer may be used as it is.

According to an embodiment of the present disclosure, the method for drying the aqueous slurry for forming an adhesive layer is not limited to any particular method. For example, a suitable method, such as convection drying, hot air drying, air blowing drying and natural drying, or a combination of two or more of them, may be used. The drying method may be hot air drying in particular.

According to an embodiment of the present disclosure, the step of drying the aqueous slurry for forming an adhesive layer may be carried out at a temperature of 50 °C to 70 °C for 10 seconds to 120 seconds.

### <Lithium Secondary Battery>

In another aspect of the present disclosure, there is provided a lithium secondary battery.

According to an embodiment of the present disclosure, the lithium secondary battery includes a positive electrode, a negative electrode, an electrolyte and a separator interposed between the positive electrode and the negative electrode.

According to an embodiment of the present disclosure, the electrodes are not particularly limited, and may be obtained by allowing an electrode active material to be adhered to an electrode current collector through a method generally known in the art. Or, the electrodes may be free-standing electrodes. Among the electrode active materials, non-limiting examples of the positive electrode active material include conventional positive electrode active materials that may be used for the positive electrodes for conventional electrochemical devices. Particularly, lithium intercalation materials, such as lithium manganese oxides, lithium cobalt oxides, lithium nickel oxides, lithium iron oxides or lithium composite oxides formed through a combination thereof, are used preferably. Non-limiting examples of the negative electrode active material include conventional negative electrode active materials that may be used for the negative electrodes for conventional electrochemical devices. Particularly, lithium intercalation materials, such as lithium metal or lithium alloys, carbon, petroleum coke, activated carbon, graphite or other carbonaceous materials, may be used. Non-limiting examples of the positive electrode current collector include foil made of aluminum, nickel or a combination thereof. Non-limiting examples of the negative electrode current collector include foil made of copper, gold, nickel, nickel or copper alloys, or a combination thereof.

The electrolyte that may be used according to the present disclosure is a salt having a structure of A⁺B⁻, wherein A⁺ includes an alkali metal cation such as Li⁺, Na⁺, K⁺ or a combination thereof, and B⁻ includes an anion such as PF₆⁻, BF₄⁻, Cl⁻, Br⁻, I⁻, ClO₄⁻, AsF₆⁻, CH₃CO₂⁻, CF₃SO₃⁻, N(CF₃SO₂)₂⁻, C(CF₂SO₂)₃⁻ or a combination thereof, the salt being dissolved or dissociated in an organic solvent including propylene carbonate (PC), ethylene carbonate (EC), diethyl carbonate (DEC), dimethyl carbonate (DMC), dipropyl carbonate (DPC), dimethyl sulfoxide, acetonitrile, dimethoxyethane, diethoxyethane, tetrahydrofuran, N-methyl-2-pyrrolidone (NMP), ethyl methyl carbonate (EMC), gamma-butyrolactone (γ-butyrolactone) or a mixture thereof. However, the present disclosure is not limited thereto.

Hereinafter, the present disclosure will be described in more detail through Examples, but the following examples are illustrative purposes only, and the scope of the present disclosure is not limited thereto.

### Example 1-1

First, boehmite (AlOOH) as inorganic particles, a polyacrylamide-based binder polymer (weight average molecular weight: about 300,000 Mw) as an amide group-containing binder polymer, polyvinyl alcohol (weight average molecular weight: about 300,000 Mw, degree of hydrolysis: 88 mol %) as an alcohol group-containing non-particle-type binder polymer, and an acrylic particle-type binder polymer (particle diameter D₅₀: about 150 nm) were introduced to water at room temperature, and then bead milling was carried out to prepare an aqueous slurry for forming an inorganic heat-resistant layer. Herein, the weight ratio of the inorganic particles, the amide group-containing binder polymer, the alcohol group-containing non-particle-type binder polymer and the acrylic particle-type binder polymer was about 91.5:5:1:2. In other words, the weight ratio of the alcohol group-containing non-particle-type binder polymer to the acrylic particle-type binder polymer was 1:2. In addition, the acrylic particle-type binder polymer maintained its particle shape in the dispersion medium.

The aqueous slurry for forming an inorganic heat-resistant layer was applied onto one surface of a porous polymer substrate (porosity 40%, thickness 9 μm) made of polyethylene through a doctor blade process, and then dried at 65 °C for 30 seconds. Herein, the inorganic heat-resistant layer had a loading amount of 5.4 mg/cm². Herein, the inorganic heat-resistant layer formed on one surface had a thickness of 1 μm.

Meanwhile, a PVDF binder polymer as a binder for an adhesive layer was introduced to water to prepare a slurry for forming an adhesive layer, which, in turn, was applied onto the inorganic heat-resistant layer through a doctor blade process, and then dried at a temperature of 60 °C for 30 seconds. An adhesive layer was formed on the other surface of the porous polymer substrate in the same manner as mentioned above. Herein, the resultant adhesive layer had a thickness of 0.75 μm.

### Example 1-2

Example 1-1 was repeated, except that the weight ratio of the inorganic particles, the amide group-containing binder polymer, the alcohol group-containing non-particle-type binder polymer and the acrylic particle-type binder polymer was about 89.5:5:1:4, and in other words, the weight ratio of the alcohol group-containing non-particle-type binder polymer to the acrylic particle-type binder polymer was 1:4.

### Example 1-3

Example 1-1 was repeated, except that the weight ratio of the inorganic particles, the amide group-containing binder polymer, the alcohol group-containing non-particle-type binder polymer and the acrylic particle-type binder polymer was about 87.5:5:1:6, and in other words, the weight ratio of the alcohol group-containing non-particle-type binder polymer to the acrylic particle-type binder polymer was 1:6.

### Comparative Example 1-1

Example 1-1 was repeated, except that the weight ratio of the inorganic particles, the amide group-containing binder polymer and the alcohol group-containing non-particle-type binder polymer was about 93.5:5:1, and in other words, the acrylic particle-type binder polymer was not used.

### Comparative Example 1-2

Example 1-1 was repeated, except that the weight ratio of the inorganic particles, the amide group-containing binder polymer, the alcohol group-containing non-particle-type binder polymer and the acrylic particle-type binder polymer was about 92.5:5:1:1, and in other words, the weight ratio of the alcohol group-containing non-particle-type binder polymer to the acrylic particle-type binder polymer was 1:1.

### Comparative Example 1-3

Example 1-1 was repeated to prepare an aqueous slurry for forming an inorganic heat-resistant layer, except that the weight ratio of the inorganic particles, the amide group-containing binder polymer and the acrylic particle-type binder polymer was about 93.5:5:1, and in other words, the alcohol group-containing non-particle-type binder polymer was not used.

The resultant aqueous slurry for forming an inorganic heat-resistant layer was attempted to be applied onto one surface of a porous polymer substrate (porosity 4000, thickness 9 μm) made of polyethylene through a doctor blade process, but it could not be applied thereto.

### Experimental Example 1

For each of the separators according to Examples 1-1 to 1-3 and Comparative Examples 1-1 to 1-3, the air permeability, heat shrinkage, resistance characteristics and water resistance were evaluated. The results are shown in the following Table 1.

TABLE 1

| | | | | Comp. | Comp. | Comp. |
|---|---|---|---|---|---|---|
| | Ex. 1-1 | Ex. 1-2 | Ex. 1-3 | Ex. 1-1 | Ex. 1-2 | Ex. 1-3 |
| Weight ratio of alcohol group- | 1:2 | 1:4 | 1:6 | 1:0 | 1:1 | 0:1 |
| containing non-particle-type binder | | | | | | |
| polymer to acrylic particle-type | | | | | | |
| binder polymer | | | | | | |
| Air permeability (sec/100 cc) | 68 | 68 | 68 | 60 | 61 | Coating |
| Heat shrinkage (%) | 2% | 2% | 2% | 12% | 10% | impossible |
| Weight (g) per 50 mm × 50 mm, | 0.0278 | 0.0277 | 0.0278 | 0.0251 | 0.0248 | |
| after coating slurry for forming | | | | | | |
| adhesive layer | | | | | | |
| Separator resistance (Ω) | 0.40 | 0.41 | 0.43 | 0.41 | 0.41 | |
| (before coating slurry for forming | | | | | | |
| adhesive layer) | | | | | | |
| Separator resistance (Ω) | 0.51 | 0.52 | 0.54 | 0.38 | 0.37 | |
| (after coating slurry for forming | | | | | | |
| adhesive layer) | | | | | | |

In Examples 1-1 to 1-3, the alcohol group-containing non-particle-type binder polymer and the water-insoluble acrylic particle-type binder polymer were contained in a desired content ratio, and thus the inorganic heat-resistant layer that ensured water resistance and the aqueous adhesive layer was formed. In addition, the separator maintained excellent air permeability, which suggests that the pore structure was stable. Further, the separator according to each of Examples 1-1 to 1-3 had a low heat shrinkage, which suggests excellent heat resistance characteristics.

On the other hand, Comparative Examples 1-1 and 1-2 used no acrylic particle-type binder polymer or used merely a small amount of acrylic particle-type binder polymer, and thus could not ensure water resistance of the inorganic heat-resistant layer. In other words, the separator (50 mm×50 mm) had a weight of 0.0247 g before coating the adhesive layer, and Examples 1-1 to 1-3 showed an increase in weight after coating the adhesive layer, and the resistance of the separator was also increased. On the contrary, Comparative Examples 1-1 and 1-2 showed an insignificant increase in weight of 0.0251 g and 0.0248 g, respectively, after coating the adhesive layer, and the resistance of the separator was rather decreased as compared to the resistance before coating the adhesive layer. This suggests that the inorganic heat-resistant layer had poor water resistance, and for example, it was partially lost. As a result, Comparative Examples 1-1 and 1-2 showed lower heat resistance characteristics. This can be confirmed through the heat shrinkage of each of Comparative Examples 1-1 and 1-2 higher than the heat shrinkage of each of Examples.

Meanwhile, Comparative Examples 1-1 and 1-2 showed a lower air permeability value as compared to Examples 1-1 to 1-3. It is thought that the air permeability was changed abnormally due to the partial loss or structural instability of the inorganic heat-resistant layer. In other words, it can be stated that the inorganic heat-resistant layer had insufficient water resistance and was lost partially to cause excessive formation of pores, or the adhesive layer could not be formed properly so that gases permeated easily therethrough abnormally.

Meanwhile, Comparative Example 1-3 used no alcohol group-containing non-particle-type binder polymer, and thus it was not possible to apply the slurry for forming an inorganic heat-resistant layer onto the porous polymer substrate.

### Example 2-1

First, boehmite (AlOOH) as inorganic particles, a polyacrylamide-based binder polymer (weight average molecular weight: about 300,000 Mw) as an amide group-containing binder polymer, polyvinyl alcohol (weight average molecular weight: about 300,000 Mw, degree of hydrolysis: 88 mol %) as an alcohol group-containing non-particle-type binder polymer, and an acrylic particle-type binder polymer (particle diameter D₅₀: about 150 nm) were introduced to water at room temperature, and then bead milling was carried out to prepare an aqueous slurry for forming an inorganic heat-resistant layer. Herein, the weight ratio of the inorganic particles, the amide group-containing binder polymer, the alcohol group-containing non-particle-type binder polymer and the acrylic particle-type binder polymer was about 91.5:5:1:2. In addition, the acrylic particle-type binder polymer maintained its particle shape in the dispersion medium.

The aqueous slurry for forming an inorganic heat-resistant layer was applied onto one surface of a porous polymer substrate (porosity 40%, thickness 9 μm) made of polyethylene through a doctor blade process, and then dried at 65 °C for 30 seconds. Herein, the inorganic heat-resistant layer had a loading amount of 5.4 mg/cm². Herein, the resultant inorganic heat-resistant layer had a thickness of 1 μm.

Meanwhile, a PVDF binder polymer as a binder for an adhesive layer was introduced to water to prepare a slurry for forming an adhesive layer, which, in turn, was applied onto the inorganic heat-resistant layer through a doctor blade process, and then dried at a temperature of 60 °C for 30 seconds. An adhesive layer was formed on the other surface in the same manner as mentioned above. Herein, the resultant adhesive layer had a thickness of 0.75 μm.

### Example 2-2

Example 2-1 was repeated, except that a wetting agent was added to the aqueous slurry for forming an inorganic heat-resistant layer in an amount of 0.5 wt % based on 100 wt % of the solid content of the slurry.

### Comparative Example 2-1

Example 2-1 was repeated, except that boehmite (AlOOH) as inorganic particles and a polyacrylamide-based binder polymer (weight average molecular weight: about 300,000 Mw) as an amide group-containing binder polymer were introduced to water at room temperature, and then bead milling was carried out to prepare an aqueous slurry for forming an inorganic heat-resistant layer. Herein, the weight ratio of the inorganic particles and the amide group-containing binder polymer was about 91.5:8.

### Comparative Example 2-2

Example 2-1 was repeated, except that boehmite (AlOOH) as inorganic particles, a polyacrylamide-based binder polymer (weight average molecular weight: about 300,000 Mw) as an amide group-containing binder polymer and polyvinyl alcohol (weight average molecular weight: about 300,000 Mw, degree of hydrolysis: 88 mol %) as an alcohol group-containing non-particle-type binder polymer were introduced to water at room temperature, and then bead milling was carried out to prepare an aqueous slurry for forming an inorganic heat-resistant layer. Herein, the weight ratio of the inorganic particles, the amide group-containing binder polymer and the alcohol group-containing non-particle-type binder polymer was about 91.5:5:3.

### Comparative Example 2-3

Example 2-1 was repeated, except that boehmite (AlOOH) as inorganic particles and polyvinyl alcohol (weight average molecular weight: about 300,000 Mw, degree of hydrolysis: 88 mol %) as an alcohol group-containing non-particle-type binder polymer were introduced to water at room temperature, and then bead milling was carried out to prepare an aqueous slurry for forming an inorganic heat-resistant layer. Herein, the weight ratio of the inorganic particles and the alcohol group-containing non-particle-type binder was about 91.5:8.

### Comparative Example 2-4

Example 2-1 was repeated, except that boehmite (AlOOH) as inorganic particles and an acrylic particle-type binder polymer (particle diameter D₅₀: about 150 nm) were introduced to water at room temperature, and then bead milling was carried out to prepare an aqueous slurry for forming an inorganic heat-resistant layer. Herein, the weight ratio of the inorganic particles and the acrylic particle-type binder polymer was about 91.5:8.

### Comparative Example 2-5

Example 2-2 was repeated, except that boehmite (AlOOH) as inorganic particles and a polyacrylamide-based binder polymer (weight average molecular weight: about 300,000 Mw) as an amide group-containing binder polymer were introduced to water at room temperature, and then bead milling was carried out to prepare an aqueous slurry for forming an inorganic heat-resistant layer. Herein, the weight ratio of the inorganic particles and the polyacrylamide-based binder polymer was about 91:8, and the content of the wetting agent was 0.5 wt % based on 100 wt % of the solid content of the aqueous slurry for forming an inorganic heat-resistant layer.

### Experimental Example 2

For each of the separators according to Examples 2-1 and 2-2 and Comparative Examples 2-1 to 2-5, coatability, water resistance, heat shrinkage, peel strength and resistance characteristics were evaluated. The results are shown in the following Table 2 with an explanation for the symbols for coatability and water resistance explained below.

TABLE 2

| | | | Comp. | Comp. | Comp. | Comp. | Comp. |
|---|---|---|---|---|---|---|---|
| | Ex. 2-1 | Ex. 2-2 | Ex. 2-1 | Ex. 2-2 | Ex. 2-3 | Ex. 2-4 | Ex. 2-5 |
| Coatability | ◯ | ⊚ | X | ◯ | ◯ | ◯ | ◯ |
| Water resistance | ◯ | ◯ | — | X | X | ◯ | X |
| Heat shrinkage | <5% | <5% | — | <5% | >10% | >10% | <5% |
| (Heat resistance) | | | | | | | |
| Peel strength | About | About | — | About | About | About | About |
| (gf/15 mm) | 50 | 50 | | 50 | 40 | 20 | 20 |
| ER (ohm) | 0.34 | 0.34 | — | 0.34 | 0.35 | 0.49 | 0.34 |
| (Resistance of | | | | | | | |
| separator single | | | | | | | |
| supply) | | | | | | | |

In the case of Examples 2-1 and 2-2, an alcohol group-containing non-particle-type binder polymer (PVA), an amide group-containing binder polymer (PAM) and an acrylic particle-type binder polymer were contained in combination, and thus it can be seen that the separator was generally excellent in coatability, water resistance, heat shrinkage, peel strength and resistance characteristics. Particularly, coatability was ensured and peel strength was improved by PVA, and water resistance was ensured by the acrylic particle-type binder polymer, and thus the separator retained a stable structure with no loss of the inorganic heat-resistant layer even during a process for forming an aqueous adhesive layer. As a result, the separator maintained excellent resistance characteristics.

Particularly, in the case of Example 2-1, coating itself was allowed, but stability tended to be slightly lowered during high-speed coating. In the case of Example 2-2, it was shown that stable coatability was ensured even during high-speed coating by virtue of the introduction of a small amount of wetting agent, which was more favorable to a mass production process.

Meanwhile, Comparative Example 2-1 included an amide group-containing binder polymer (PAM) alone, and thus the slurry existed in the form of water droplets and did not spread on the porous polymer substrate, which made it impossible to form a uniform coating layer.

Comparative Example 2-2 includes PAM in combination with PVA, and thus allowed coating of the inorganic heat-resistant layer, and ensured a certain level of peel strength and heat resistance characteristics. However, due to the absence of an acrylic particle-type binder polymer, water resistance of the inorganic heat-resistant layer could not be ensured sufficiently, and thus it was likely that loss of the inorganic heat-resistant layer may occur in the subsequent process for forming an aqueous adhesive layer. In other words, Comparative Example 2-2 was good in terms of coatability, peel strength and heat resistance characteristics, but showed a limitation in terms of water resistance.

Comparative Example 2-3 included PVA alone, and thus allowed coating. However, due to the absence of PAM, the inorganic heat-resistant layer showed insufficient binding force and structural stability, and thus the separator tended to show degradation of water resistance and heat resistance characteristics.

Comparative Example 2-4 included an acrylic particle-type binder polymer alone, and thus ensured coating and water resistance. However, due to the absence of PAM and PVA, the adhesion between the inorganic heat-resistant layer and the porous polymer substrate was insufficient, and thus the separator showed degradation of peel strength and heat resistance characteristics and also showed relatively poor resistance characteristics.

Comparative Example 2-5 included PAM and a wetting agent, and thus allowed coating. However, due to the absence of PVA and an acrylic particle-type binder polymer, peel strength and water resistance could not be ensured sufficiently, and thus it was difficult to form an adhesive layer, and the peel strength of the separator tended to decrease.

As a result, it can be seen that PVA may contribute to improvement of coatability and peel strength, the acrylic particle-type binder polymer may contribute to ensuring water resistance, and PAM may contribute to the heat resistance characteristics and structural stability of the inorganic heat-resistant layer. It is shown that when the above-mentioned components are contained in combination, each of the physical properties may be improved complementarily, and thus the separator may ensure excellent overall performance.

### [Methods of Measurement]

### <Measurement of Weight of Separator>

A separator not coated with an adhesive layer on the inorganic heat-resistant layer and the porous polymer substrate according to each of Examples and Comparative Examples was cut into a size of 50 mm×50 mm and weighed (0.0247 g), and then a separator coated with an adhesive layer on the inorganic heat-resistant layer and the porous polymer substrate according to each of Examples and Comparative Examples was cut into the same size and weighed. Then, comparison of the weight was carried out.

### <Measurement of Air Permeability>

The air permeability of the separator according to each of Examples and Comparative Examples was measured according to ASTM D726-94. The air permeability was measured by using a Gurley densometer. Herein, the Gurley value means the resistance against air flow. The air permeability value described herein is expressed by the time (seconds), i.e. air permeation time, required for 100 cc of air to pass through the cross-section of the separator prepared according to each of Examples and Comparative Examples having an area of 1 in² under a pressure of 12.2 in H₂O.

### <Determination of Heat Shrinkage>

A separator prepared according to each of Examples and Comparative Examples was cut into a size of 50 mm×50 mm, placed between A4 paper sheets, introduced to a convection oven at 130 °C and allowed to stand therein for 30 minutes, and then the heat shrinkage was determined in the machine direction (MD) and the transverse direction (TD).

Herein, the heat shrinkage was calculated according to the formula of [(Initial length−Length after heat treatment)/(Initial length)×100].

### <Determination of Resistance Characteristics>

A coin cell was manufactured by using a separator prepared according to each of Examples and Comparative Examples through the following method, and the resistance of the separator was measured by electrochemical impedance spectroscopy (EIS). Herein, EIS was performed by using Solartron analytical EIS instrument available from Solartron Co., Ltd., and the resistance value was measured in a frequency range of 100,000 Hz to 10,000 Hz.

The coin cell was prepared as follows. A separator prepared according to each of Examples and Comparative Examples was cut into a size of 19 φ and prepared as a separator for a coin cell to assemble a CR2016 coin cell. Then, an electrolyte including 1 M LiPF₆, ethylene carbonate (EC) and ethylmethyl carbonate (EMC) (3/7 v/v) and 2 wt % of vinylene carbonate (VC) was injected into the coin cell without any separate electrode.

### <Measurement of Peel Strength>

A separator according to each of Examples and Comparative Examples was cut into a size of 15 mm×100 mm. A double-sided adhesive tape was attached onto a glass plate, and the separator was attached thereto in such a manner that the porous coating layer surface of the separator might be adhered with the adhesive tape. Then, the end of the adhered separator was mounted to an UTM device (LLOYD Instrument LF Plus), and 1800 peeling was carried out at a rate of 300 mm/min to measure the force required to separate the inorganic heat-resistant layer and the porous polymer substrate from each other.

### <Measurement of Weight Average Molecular Weight>

The weight average molecular weight was measured by using gel permeation chromatography (GPC). Detailed GPC analysis condition is as follows:

GPC analysis device: ACQUITY PAC (Waters Corp.), Column: PL gel Mixed-B+C (Agilent), Column temperature: room temperature (RT, 20 °C to 25 °C), Eluent: DMF/0.05 M LiBr, Flow rate: 1.0 mL/min, Detector: Waters 2414 RI detector, Sample concentration: ~1 mg/mL (0.45 μm syringe filter), Injection amount: 10 μL, Calibration curve: PMMA

### <Determination of Degree of Hydrolysis>

A predetermined amount of polyvinyl alcohol-based binder polymer was weighed accurately and dissolved in a mixed solvent of alcohol and water, and then an excessive amount of standardized aqueous sodium hydroxide (NaOH) solution was added thereto to carry out saponification. Then, the remaining sodium hydroxide was reversely titrated with standardized aqueous hydrochloric acid (HCl) solution to calculate the content of non-saponified residue (—OAc) in a sample from the amount of consumed hydrochloric acid. Based on this, the degree of hydrolysis was calculated in the unit of percentage (%).

### <Evaluation of Coatability>

An aqueous slurry for forming an inorganic heat-resistant layer according to each of Examples and Comparative Examples was applied onto a porous polymer substrate through a doctor blade process, and then it was observed whether or not the slurry was uniformly applied on the substrate surface in the form of a continuous film. When the slurry forms a continuous coating layer while not forming water droplet forms on the substrate surface, it was evaluated as ensuring coatability. In addition, when the same continuous coating layer was retained even under a high-speed coating condition, the coatability was evaluated as excellent (O). When such a coating layer was formed merely under a low-speed condition, the coatability was evaluated as good (O). Further, when formation of a continuous coating layer was impossible, the coatability was evaluated as poor (X).

### <Evaluation of Water Resistance>

A separator having an inorganic heat-resistant layer according to each of Examples and Comparative Examples was subjected to secondary coating with water, followed by drying, and then comparison of a change in weight and resistance of the separator before and after the secondary coating was carried out to evaluate the water resistance. When the separator had the same weight due to no loss or insignificant loss of the inorganic heat-resistant layer, it was judged as ensuring water resistance. On the contrary, when the weight decreased after the secondary coating, it was regarded as indicating partial loss of the inorganic heat-resistant layer and judged as having poor water resistance.

### <Measurement of Particle Diameter of Acrylic Particle-Type Binder Polymer>

The particle diameter (D₅₀) of the acrylic particle-type binder polymer was measured by using a laser diffraction particle size analyzer. Specifically, after the acrylic particle-type binder polymer was dispersed in an aqueous dispersion medium, the particle size distribution was measured, and the particle diameter corresponding to 50% in the cumulative particle size distribution was defined as D₅₀.

### <Measurement of Loading Amount>

The loading amount of the inorganic heat-resistant layer was calculated from a difference in weight per unit area of the porous polymer substrate before and after forming the inorganic heat-resistant layer. Specifically, the weight of a predetermined area of the porous polymer substrate and that of the separator having the inorganic heat-resistant layer were measured individually, and then the difference between them was divided by the unit area to calculate the loading amount (mg/cm²).

What is claimed is:

1. A separator for a lithium secondary battery, comprising:
a porous polymer substrate; and
an inorganic heat-resistant layer present on at least one surface of the porous polymer substrate and comprising inorganic particles, an alcohol group-containing non-particle-type binder polymer and an acrylic particle-type binder polymer.

2. The separator for the lithium secondary battery according to claim 1,
wherein the alcohol group-containing non-particle-type binder polymer comprises a vinyl alcohol-derived repeating unit.

3. The separator for the lithium secondary battery according to claim 1,
wherein the alcohol group-containing non-particle-type binder polymer has a degree of hydrolysis of 80 mol % to 95 mol %.

4. The separator for the lithium secondary battery according to claim 1,
wherein the acrylic particle-type binder polymer has a particle diameter (D₅₀) of 50 nm or more and 500 nm or less.

5. The separator for the lithium secondary battery according to claim 1,
wherein a weight ratio of the acrylic particle-type binder polymer to the alcohol group-containing non-particle-type binder polymer is larger than 1.

6. The separator for the lithium secondary battery according to claim 1,
wherein a weight ratio of the alcohol group-containing non-particle-type binder polymer to the acrylic particle-type binder polymer is in a range of 1:1.5 to 1:20.

7. The separator for the lithium secondary battery according to claim 1,
wherein the inorganic heat-resistant layer further comprises an amide group-containing binder polymer.

8. The separator for the lithium secondary battery according to claim 7,
wherein the amide group-containing binder polymer comprises a polyacrylamide-based binder polymer.

9. The separator for the lithium secondary battery according to claim 7,
wherein the amide group-containing binder polymer is a non-particle-type amide group-containing binder polymer.

10. The separator for the lithium secondary battery according to claim 1,
wherein the inorganic heat-resistant layer comprises, based on 100 wt % of the inorganic heat-resistant layer, 0.1 wt % to 10 wt % of the alcohol group-containing non-particle-type binder polymer and 0.2 wt % to 20 wt % of the acrylic particle-type binder polymer.

11. The separator for the lithium secondary battery according to claim 1,
wherein the inorganic heat-resistant layer further comprises a wetting agent in an amount of less than 1 wt % based on 100 wt % of the inorganic heat-resistant layer.

12. The separator for the lithium secondary battery according to claim 1,
wherein the inorganic particles comprise boehmite (AlOOH).

13. The separator for the lithium secondary battery according to claim 1, further comprising:
an adhesive layer present on at least one surface of the inorganic heat-resistant layer and comprising at least one adhesive-layer binder polymer.

14. The separator for the lithium secondary battery according to claim 13,
wherein the adhesive-layer binder polymer comprises a particle-type binder polymer, a non-particle-type binder polymer or a combination thereof.

15. The separator for the lithium secondary battery according to claim 13,
wherein the adhesive-layer binder polymer comprises an acrylic binder polymer, a polyvinylidene fluoride (PVDF)-based binder polymer or a combination thereof.

16. A lithium secondary battery comprising: a positive electrode; a negative electrode;
and the separator according to claim 1 interposed between the positive electrode and the negative electrode.
